(19) United States
(12) Patent Application Publication
(10) Pub. No.: US 2018/0069964 A1
(43) Pub. Date: Mar. 8, 2018

(54) ELECTRONIC BRIDGE BETWEEN MOBILE-TELECOMMUNICATION DEVICE AND PUBLIC-SWITCHED-TELEPHONE-NETWORK (PSTN) OR VOICE-OVER-INTERNET-PROTOCOL (VOIP) DEVICE

(71) Applicant: Rocke R. Koreis, Seattle, WA (US)

(72) Inventor: Rocke R. Koreis, Seattle, WA (US)

(21) Appl. No.: 15/694,522

(22) Filed: Sep. 1, 2017

Related U.S. Application Data
(60) Provisional application No. 62/446,168, filed on Jan. 13, 2017.
(60) Provisional application No. 62/382,797, filed on Sep. 2, 2016.

(51) Int. Cl. H04M 7/00; H04M 3/42

(52) U.S. Cl. CPC H04M 7/009; H04W 84/14; H04M 3/42178

(57) ABSTRACT

In an embodiment, a bridge circuit is configured for connecting a desk phone (e.g., a VoIP phone) to a mobile device (e.g., a smart phone), while allowing the existing desk-phone VoIP/PSTN system (e.g., a PBX system) to be eliminated with significant savings in reduced telecommunication-infrastructure costs. The bridge circuit can be powered through traditional wall power, and can include a CAT 5 cable port with Power Over Ethernet (PoE), a PSTN port such as an RJ11 port, a set of electronics that provide wireless connectivity to the mobile device, a control circuit, and a set of software instructions for programming the desk phone to communicate with the bridge circuit and for providing other features such as conference calling, putting a call on hold, and transferring contact information from the mobile device to the desk phone or vice-versa.

### PRIORITY CLAIMS

This application claims benefit of U.S. Provisional Patent Application No. 62/283,797, entitled “MOBILE TELECOMMUNICATIONS DEVICE TO VOICE OVER INTERNET PROTOCOL DEVICE BRIDGE,” and filed Sep. 2, 2016, and of U.S. Provisional Patent Application No. 62/446,168, entitled “MOBILE-TELECOMMUNICATION-TO-PUBLIC-SWITCHED-TELEPHONE-NETWORK/VOICE-OVER-INTERNET-PROTOCOL-DEVICE BRIDGE AND RELATED SYSTEMS,” and filed Jan. 13, 2017, the disclosures of which are incorporated herein in their entirety.

### TECHNICAL FIELD

An embodiment relates generally to an electronic system for “fooling” a Voice-over-Internet-Protocol (VoIP) telephone or Public-Switched-Telephone-Network (PSTN) telephone into “thinking” that it is connected to a VoIP system or PSTN system while it is, in fact, making calls through a mobile device over a cellular network. More specifically, an embodiment relates to a VoIP/PSTN-to-mobile-device bridge that allows a VoIP or PSTN desk phone to be disconnected from the VoIP/PSTN system and connected to a mobile device, such as a smart phone, while the desk phone maintains some or all of its capabilities and conveniences.

### BACKGROUND

Business entities are always looking for ways to reduce expenses.

One large expense that an entity typically incurs on an ongoing basis is the expense for its telecommunications system, which typically includes employee desk phones and mobile devices such as smart phones.

In an effort to reduce telecommunication expenses, many entities are moving, or have already moved, to a “one-device” policy where each employee can have either a mobile device or a desk phone, but not both.

Because many employees have become reliant on their mobile devices for not only telecommunications, but also for email and internet access, an employee typically chooses a mobile device has is company-provided telecommunication device.

Unfortunately, choosing a mobile device at the expense of a desk phone typically results in a loss of productivity for the employee while he/she is in the office. For example, to make a call on a mobile device such as a smart phone, the employee typically must enter a password, find and activate the phone application, wait for the phone application to load, and then make the phone call. In contrast, with a desk phone, the employee would simply pick up the handset and dial a number, which typically would be an extension number that is shorter (e.g., four digits) than a standard ten-digit U.S. telephone number. At an enterprise level, there is a significant loss of productivity in the former procedure, particularly when multiplied over many employees and many occurrences per employee.

At the same time, while entities reduce the ongoing expense of the VoIP system, they are “throwing away” thousands of expensive desk phones, costing hundreds of dollars apiece, that are no longer being used due to employees choices to forgo desk phones in favor of mobile devices. For example, entities with one-device policies are sending to surplus thousands of sophisticated VoIP telephones that are no longer connected to their Private Branch Exchange (PBX) systems.

Consequently, even though an entity may reduce ongoing expenses for its telecommunications system by instituting a one-device policy, the cost savings may be significantly reduced, cancelled, or even surpassed, by increased costs due to employees' loss of productivity in using a mobile device instead of a desk phone and due to surplussing of desk phones.

### SUMMARY

Accordingly, there exists a need for a method and apparatus that allows for disconnecting a VoIP/PSTN system, such as the PBX system, thus saving significant expense at an enterprise level, connecting a desktop apparatus that simulates a VoIP/PSTN system (or other phone system) to the desk phone, and wirelessly making calls, via the desktop apparatus, through a mobile device such as a smart or cell phone.

An embodiment is a desk-phone-VoIP/PSTN-to-mobile-device bridge that eliminates the need for a password and using a phone application on the mobile device prior to making calls, maintains the productivity of the employee by utilizing the convenience of a desk phone (e.g., Internet-Protocol (IP) phone), and allows an entity to greatly reduce its internal-phone-system VoIP/PSTN expenses by eliminating bandwidth from the backend system while maintaining its investment in the desk phone.

In more detail, an embodiment comprises a method and apparatus for connecting an IP Phone to a mobile device, such as a smart phone, while allowing the existing desk-phone VoIP/PSTN system (e.g., a PBX system) to be eliminated with significant savings to the entity in reduced telecommunication infrastructure costs. An embodiment employs a small VoIP/PSTN-to-mobile-device bridge, which may be powered through traditional wall power and includes a CAT 5 cable port with Power Over Ethernet (POE), a PSTN port such as an RJ11 port, a set of electronics that provide wireless connectivity to a mobile device, and a set of software instructions for programming the IP Phone to communicate with the bridge and for providing other features such as transferring contact information from the mobile device to the desk phone or vice versa.

In an embodiment, a VoIP/PSTN-to-mobile-device bridge may also have the capability to use the mobile device as an internet gateway, allowing the mobile device to identify the model of IP Phone, to download the proper software or firmware from the internet through the mobile device, and to use the software or firmware to automatically configure the IP Phone so that it may be disconnected from the entity's PBX system and make calls transparently through the mobile device.

Since, in an embodiment, the VoIP/PSTN-to-mobile-device bridge is connected wirelessly to an entity-controlled mobile phone, the entity's Information Technology (IT) department may maintain control of the VoIP/PSTN-to-mobile-device bridge, and, through a mobile-device application, be allowed to make changes, such as software/firmware and security upgrades, to the VoIP/PSTN-to-mobile-device bridge and to the IP Phone.

Because not all entities will have existing desk phones to connect to the bridge (particularly after an entity eliminates its VoIP/PSTN system), in an embodiment, an integrated approach combines the desk phone and bridge in one unit with a docking/charging station for the mobile-phone device. This allows the entity to set up a complete telephone system (e.g., each employee can have both a desk phone and a mobile device) without the need for the entity to maintain a PBX system or other connection to a wired telephone company such as a PSTN.

### BRIEF DESCRIPTION OF THE DRAWINGS

Features and advantages of embodiments will become more readily appreciated as the same become better understood by reference to the following detailed description when considered in connection with the accompanying drawings, wherein:

FIG. 1 is a diagram of a VoIP/PSTN telephone and supporting PBX or other infrastructure in large existing telephone systems.

FIG. 2 is a diagram of a system including a VoIP or PSTN desk phone that is disconnected from a large PBX or other phone system, according to an embodiment.

FIG. 3 is a diagram of a desktop VoIP/PSTN-to-mobile-device bridge circuit and its inner components and workings, according to an embodiment.

FIG. 4 is a diagram of the two-way interaction of a system that includes an interconnected desk phone, bridge circuit, and mobile device, according to an embodiment.

FIG. 5 is a flow diagram of the steps for configuring the VoIP or PSTN desk phone of FIGS. 2 and 4 to operate while connected to a mobile device and while disconnected from a PBX or other phone system, according to an embodiment.

FIG. 6 is a flow diagram showing the maintenance and support flow for an entity to control, maintain, and update the VoIP/PSTN-to-mobile-device bridge circuit, according to an embodiment.

FIG. 7 is a flow diagram showing how a call is made through the bridge circuit of FIGS. 2-4, according to an embodiment.

FIG. 8 is a diagram of a system including a desk phone having, built in, the capabilities of the bridge circuit described above in conjunction with FIGS. 2-7, a docking station with wired or wireless power charging for the mobile device, and a wired or wireless handset with an integrated detachable wireless headset, according to an embodiment.

FIG. 9 is a diagram of the system of FIG. 8 with the station/receptacle detached from the desk phone, or otherwise omitted from the system, according to an embodiment.

FIG. 10 is a diagram of the system of FIG. 8 with the station/receptacle detached from the desk phone of FIG. 8 (or the desk phone otherwise omitted from the system) and in wired or wireless communication with a repurposed desk phone, according to an embodiment.

### DETAILED DESCRIPTION

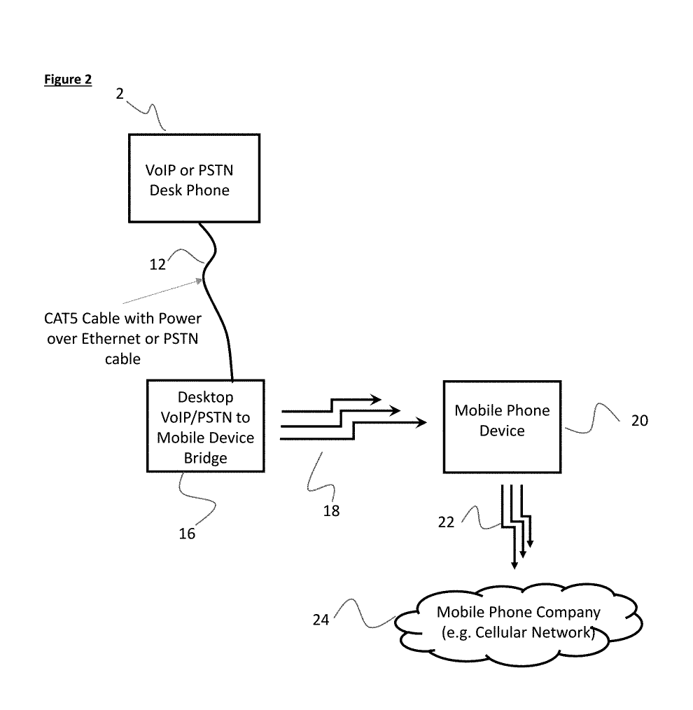

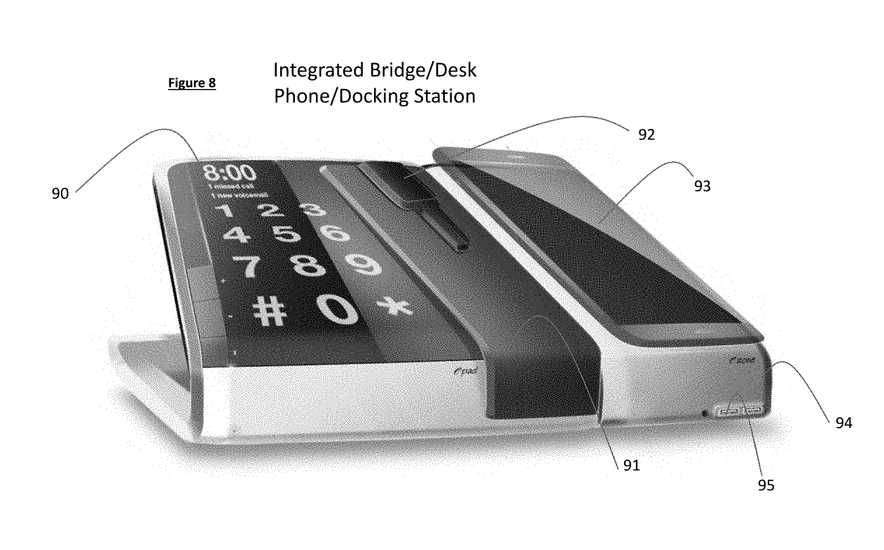

Referring to the Figures, wherein like numerals indicate like or corresponding parts throughout the several views, in FIG. 2, a traditional VoIP/PSTN telephone is shown at 2 connected a VoIP/PSTN mobile device bridge at 16, according to an embodiment. For purposes of illustration and not to be in any way limiting, the following description will make reference to the FIG. 2 application of the VoIP/PSTN-to-mobile-device bridge 16. However, it will be appreciated that the principles disclosed herein are equally applicable to a desk phone other than a VoIP or PSTN desk phone, and to a customized desk phone that also includes a docking station (see, for example, FIG. 8).

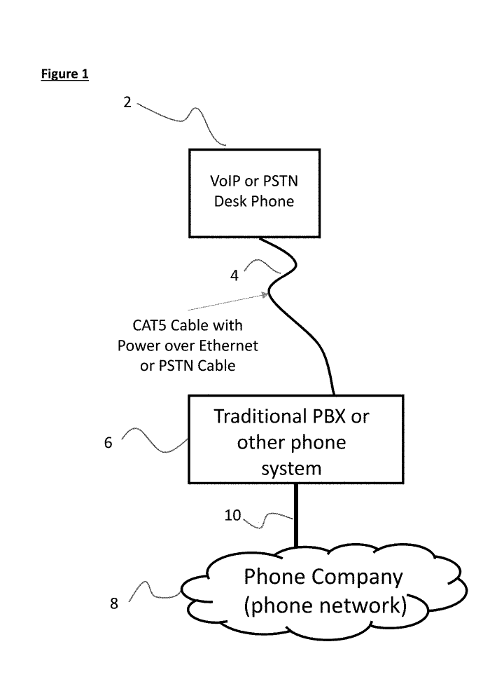

Referring now to FIG. 1, a typical telephone system is described with a VoIP or PSTN desk telephone 2 connected to a PBX or other phone-control system 6 via a cable 4. The PBX or other phone-control system is connected to the phone company 8 (e.g., a PSTN) through a connection 10.

FIG. 2 shows how the VoIP or PSTN desk telephone 2 can be disconnected from the PBX or other phone-control system 6 and from the phone company 8 of FIG. 1, according to an embodiment.

The desk phone 2 can instead be connected to a desktop-VoIP/PSTN-to-mobile-device bridge circuit (hereinafter “bridge” or “bridge circuit”) 16 via a cable 12, which can be, for example, a CAT5 cable for VoIP phones or a cable compatible with a PSTN phone or other telephone. The bridge 16 is configured to take one or more commands from the desk phone 2, such as a phone number to be called/connected, and is configured to transmit the one or more commands over a wireless channel/connection 18 (e.g., the air) to the mobile phone device 20. The wireless connection 18 may be effected according to any suitable wireless protocol such as Wi-Fi or Bluetooth®. The mobile phone device 20 is configured to connect the call over another wireless channel/connection 22 through the mobile-phone network/company 24. In this manner, the bridge 16 is configured to allow the user of the desk phone 2 to complete the call via the mobile-phone device 20 and mobile-phone network/company 24 even while the desk phone is disconnected from the PBX or other phone system 6 and phone network/company 8 of FIG. 1.

Still referring to FIG. 2, one or more of the desk phone 2, bridge 16, and mobile device 20 can include circuitry for performing any of the functions described herein, and the circuitry can be hardwired for such operation, can be configured for such operation by software or firmware, or can be configured according to a combination or subcombination of hardwiring, software, and firmware.

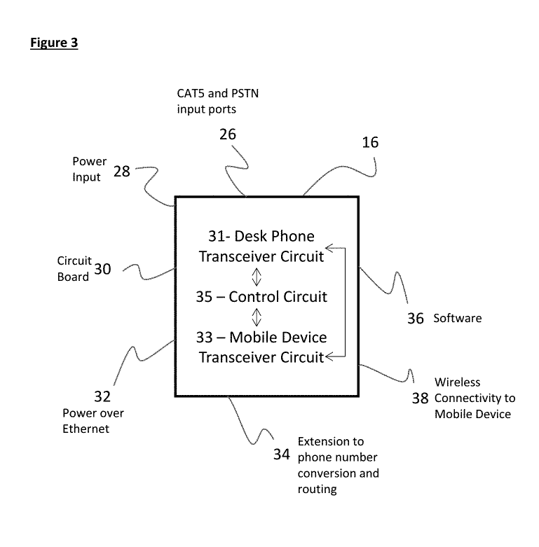

FIG. 3 is a diagram of the VoIP/PSTN-to-mobile-device bridge 16, according to an embodiment. The bridge 16 is a desk-top device that includes a power input 28, and Category 5 (CAT-5) cable and PSTN cable input ports 26. The power input 28 can be, for example, a jack configured to receive a connector from an AC adapter (e.g., a “wall wart”), or can be a wall-power receptacle (e.g., a 120 VAC receptacle in the U.S.) Circuitry on an internal circuit board(s) 30 is configured to control the functions of the bridge 16, and includes a memory configured to store software 36, which configures the bridge to configure any connected VoIP or PSTN desk phone 2 to perform bridge functions such as routing calls from the desk phone through a mobile device via a wireless channel 38, and to perform other convenient functions such as extension-number-to-phone-number conversion and routing 34. The CAT-5 cable can also include Power over Ethernet 32 to power VoIP phones that use this configuration. If the bridge 16 is configured exclusively for PoE use, then the power input 28 can be omitted from the bridge.

Circuitry on board the bridge circuit 16, e.g., on the internal circuit board(s) 30, includes a desk-phone transceiver circuit 31, a mobile-device transceiver circuit 33, and a control circuit 35, according to an embodiment. The circuits 31, 33, and 35 are electronically interconnected with one another in any suitable manner.

The desk-phone transceiver circuit 31 can be any suitable transceiver circuit, and is configured to communicate signals and data between the desk phone 2 and the control circuit 35, and to communicate signals and data between the desk phone 2 and the mobile device 20 via the transceiver circuit 33. For example, the transceiver circuit 31 can be configured to communicate with the desk phone 2 over a wireless channel according to, e.g., a Bluetooth® or other wireless protocol, or over a wired channel, e.g., a CAT cable.

Similarly, the mobile-device transceiver circuit 33 can be any suitable transceiver circuit, and is configured to communicate signals and data between the mobile device 20 and the control circuit 35, and to communicate signals and data between the mobile device 20 and the desk phone 2 via the transceiver circuit 31. For example, the transceiver circuit 33 can be configured to communicate with the mobile device 20 over a wireless channel, e.g., a CAT cable.

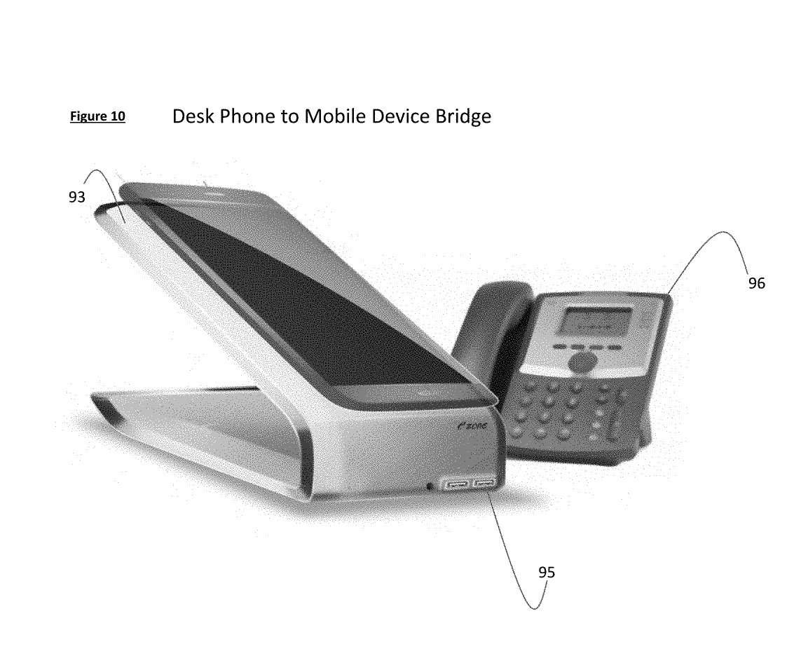

And the control circuit 35 is configured to control the respective configurations, operations, and functions of one or more of the desk-phone transceiver circuit 31, the mobile-device transceiver circuit 33, the desk-phone 2, the mobile device 20, and a mobile-device dock (see FIGS. 8 and 10 below). For example, the control circuit 35 is configured to implement, or to cause the implementation of, the operations and functions described herein. The control circuit 35 can be, or include, any suitable circuit, such as a microprocessor, a microcontroller, a field-programmable gate array (FPGA), volatile memory, non-volatile memory, or a combination of two or more of these or other circuits. Furthermore, the control circuit 35 can have a hardwired configuration, can be configured by software or firmware or another set of configuration data, or can be configured by a combination or subcombination of these configuration techniques.

Still referring to FIG. 3, alternate embodiments of the bridge circuit 16 are contemplated. For example, one or both of the transceiver circuits 31 and 33 can be part of the control circuit 35 instead of separate therefrom. Furthermore, the bridge circuit 16 can include other circuitry such as power-supply circuitry, non-volatile memory circuitry, volatile memory circuitry, Ethernet and Universal Serial Bus (USB) ports and circuitry (a device external to the bridge circuit 16 can provide power via these ports), telephone circuitry, and wireless-communication circuitry (e.g., Bluetooth®, Wi-Fi).

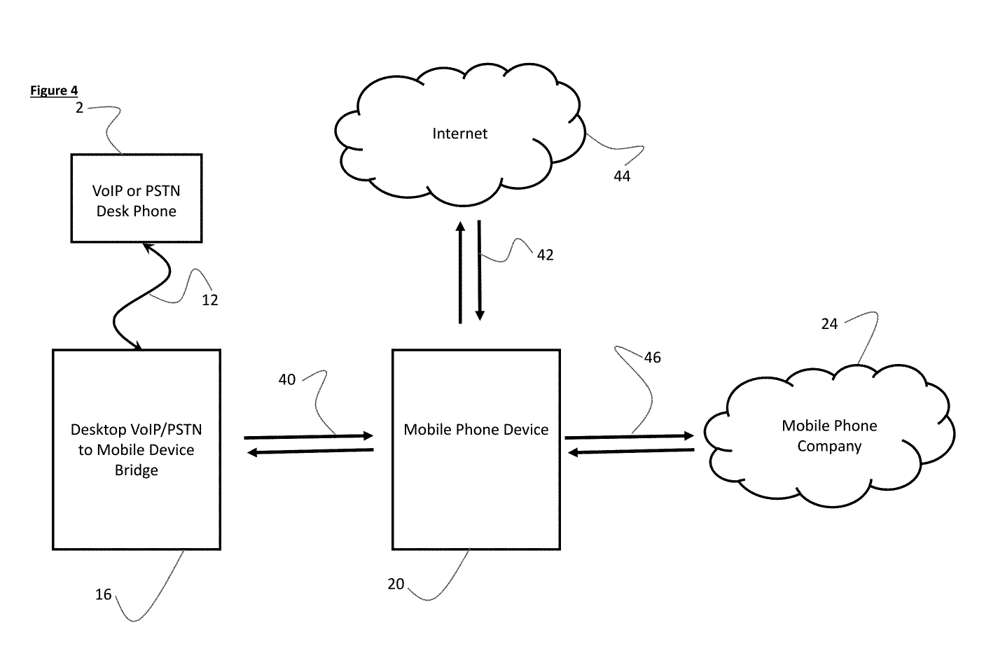

FIG. 4 is a diagram that details how the bridge 16 communicates with the desk phone 2 and routes calls through the mobile-phone device 20 via a wireless connection/channel 40, according to an embodiment. The bridge 16 is configured to establish two-way communication with the desk phone 2 through the cable 12. This two-way communication allows the bridge 16 to determine the connection requirements of the desk phone 2 and to load appropriate software to configure the desk phone and to establish a connection. If the bridge 16 does not have the proper configuration software or firmware, it is configured to use the mobile-phone device's internet connection 42 to download the appropriate software or firmware from a location (e.g., a cloud server) via the cloud/internet 44. To make a call, a user (not shown in FIG. 4) picks up the handset or headset attached to the desk phone 2 and enters a telephone number. The bridge 16 is configured to interpret the phone number as a phone number or extension number, and as a command to dial the phone number or extension number. If the number is a telephone number, then the bridge is configured to use the mobile-phone device 20 to make the telephone connection through the mobile-phone device's wireless connection 46 to the mobile-phone network/company 24, thus eliminating the need for the user to first enter a password on the mobile-phone device 20 and for a connection between the desk phone 2 and a PBX, other phone-system control, or a phone network/company (e.g., a PSTN) as described in FIG. 1.

The desk phone 2 is configured to execute common commands other than “dial a phone number,” including “mute,” “hold,” or volume. The bridge 16 can be configured to reject a command (e.g., “hold”) from the desk phone 2 if the mobile-phone device 20 cannot execute the command. Alternatively, the bridge 16 can be configured to pass along, to the mobile-phone device 20, a command that the mobile-phone device 20 does not or cannot execute (e.g., ignores), and the mobile-phone device can be configured to send to the bridge 16 an indication that the mobile-phone device did not or could not execute the command.

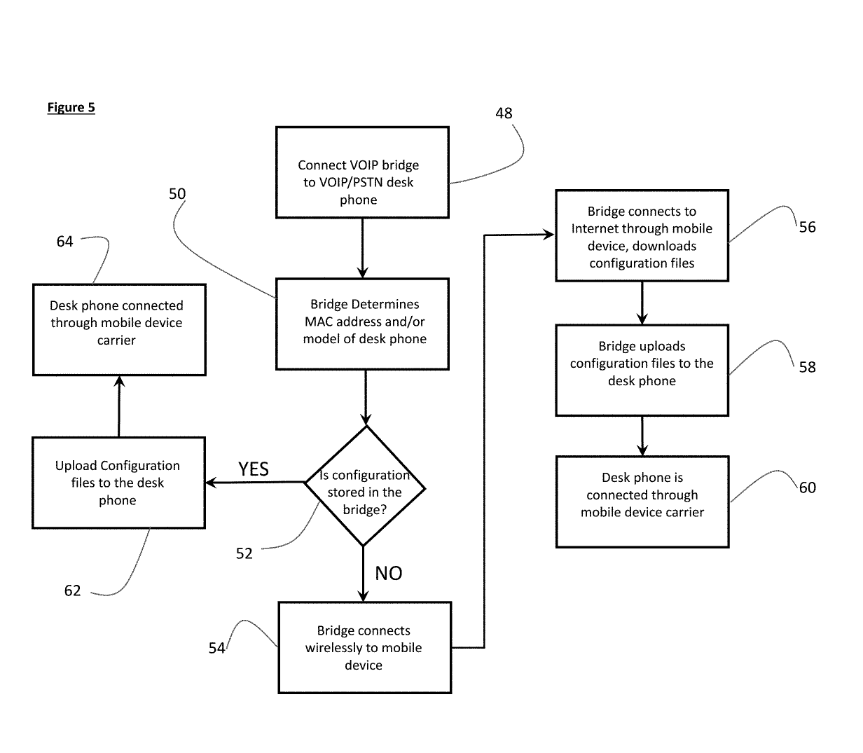

FIG. 5 is of a flow diagram of a setup and configuration flow of the system of FIG. 4, according to an embodiment.

Referring to FIGS. 4 and 5, after a desk phone 2 is first connected to the bridge 16 at a step 48, the bridge determines the Media Access Control (MAC) address of the desk phone at a step 50.

If, at a step 52, the desk phone's configuration is stored in the bridge 16, the bridge uploads one or more configuration files to the desk phone 2 at a step 62, “fooling” the desk phone into thinking it is connected to a telephone system (e.g., a VoIP telephone system), and thus allows calls to be made through the mobile device 20 and mobile-device carrier 24 at a step 64.

If the desk phone's configuration is not stored in the bridge 16, then the bridge connects wirelessly to the mobile-phone device 20 at a step 54 and uses the internet connection 42 of the mobile device to download the appropriate configuration files from the internet at a step 56. The procedure for downloading configuration files from the internet 44 may be accomplished through the use of an application residing on the mobile-phone device.

Next, the bridge 16 uploads the configuration files to the desk phone 2 and establishes a connection to the desk phone at a step 60.

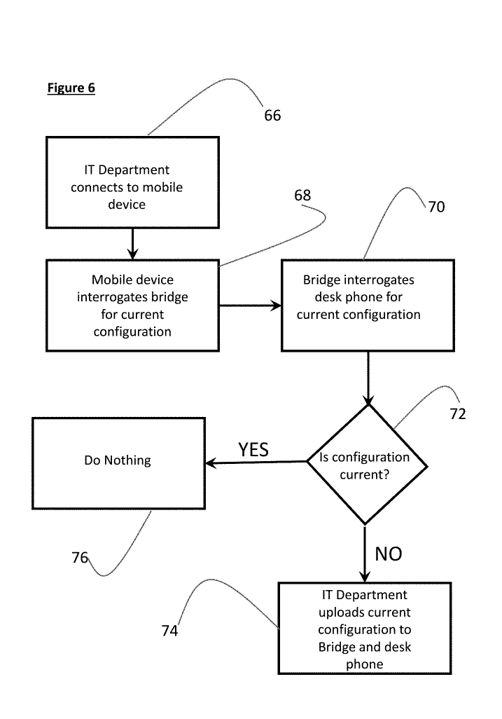

FIG. 6 is a flow diagram illustrating how an entity maintains control over its telecommunication system that includes one or more bridges 16, according to an embodiment. In more detail, FIG. 6 describes how an Information Technology (IT) department of the entity maintains control of each bridge 16, desk phone 2, and mobile-phone device 20 in the entity's telecommunication system, according to an embodiment.

At a step 66, the IT department connects to the mobile-phone device 20 through a software application residing on, and executed by, the mobile-phone device.

At a step 68, the application executed by the mobile-phone device 20 causes the mobile-phone device to interrogate the bridge 16 for its current configuration.

And, at a step 70, the application causes the mobile-phone device 20 to command the bridge 16 to interrogate the desk phone 2 for its current configuration.

If, at a step 72, the mobile-phone device 20, under the control of the application, determines that the configurations of the bridge 16, desk phone 2, and mobile-phone device are current (e.g., are of the latest available versions approved by the IT department, have the security features currently required by the IT department), then, at a step 76, the mobile-phone device 20 takes no further action.

But if, at a step 74, one or more of the configurations are not current, then the IT department can use the mobile-phone-device 20, while running the application, to upload current configuration files to one or more of the bridge 16, desk phone 2, and mobile-phone device.

In this manner, the IT department can maintain control over the system and ensure that the configurations (including their security features), are up to date.

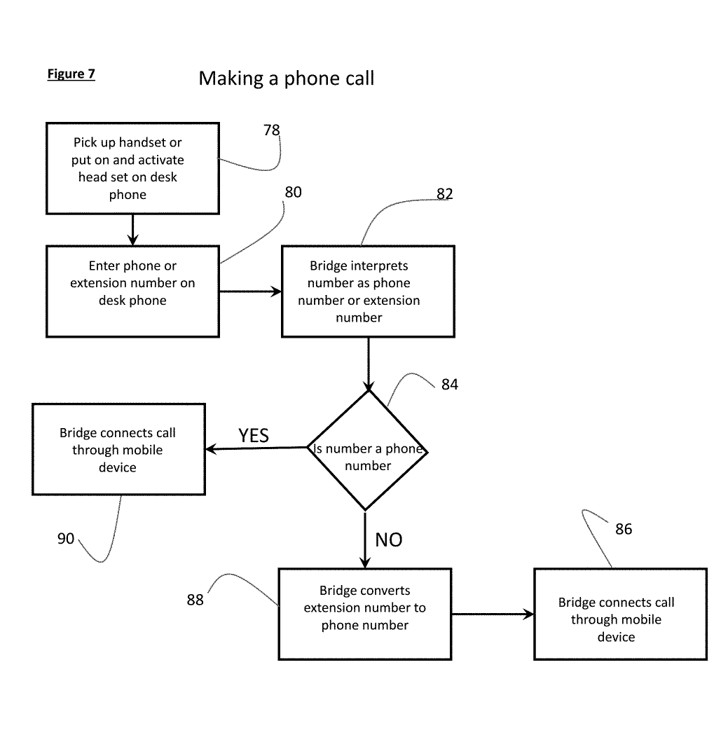

FIG. 7 is a flow diagram that illustrates how one makes a phone call using the system of FIG. 4, according to an embodiment. In the described embodiment, it is assumed that when the bridge 16 is connected to the desk phone 2, and the desk phone is disconnected from the PBX or other phone system described in FIG. 1, all functions of the desk phone are maintained while the bridge routes calls through the mobile-phone device 20 instead of a PBX or other wired phone system.

Referring to FIGS. 4 and 7, at a step 78, to make a call, a user (not shown in FIGS. 4 and 7) picks up the handset of the desk phone 2 or activates a head set of the desk phone.

At a step 80, the user enters a telephone number or extension number into the desk phone 2, and the desk phone provides a dial command, including whether the user entered a telephone number or extension number, to the bridge 16.

At a step 82, the bridge 16 receives the command and interprets the number as a phone number or extension number as indicated by the command.

At a step 84, if the bridge 16 determined, at the step 82, that the number is a telephone number, then, at a step 90, the bridge connects the call through the mobile-phone device 20 and a mobile-phone network/company (e.g., a cellular network like T-Mobile®, Sprint®, Verizon®, or AT&T®), thus eliminating the need for a wired PBX or other phone system and, therefore, eliminating the need for a connection to a wired telephone company (e.g., a PSTN such as Qwest® or a VOIP Company).

But at the step 84, if the bridge 16 determined, at the step 82, that the number is an extension number, then, at a step 88, the bridge, under the control of internal software, converts the extension number (e.g., a four-digit extension number) to a full telephone number (e.g., a ten-digit U.S. telephone number or a multi-digit telephone number for a country or region outside of the U.S.), and, at a step 86, proceeds to connect the call through the mobile-phone device 20 and mobile-phone company by causing the mobile-phone device to dial the full telephone number.

Note that in an embodiment, the bridge 16 maintains all features available on the desk phone 2 active. A user, therefore, can use the desk phone 20 to place calls on hold, to mute calls, to change call volume, to forward calls, to place calls on speaker, to conference in one or more other parties/lines, or to perform any of the other features available on the desk phone just as the user did, or could have, when the desk phone was connected to the PBX system as described above in conjunction with FIG. 1.

FIG. 8 is a diagram of an embodiment of an integrated bridge/desk-phone/docking system, according to an embodiment.

Not all entities having, or will have, existing VoIP or PSTN telephones to integrate with the bridge 16 (FIGS. 2-4), and thus will have a need for a complete system.

Therefore, referring to FIG. 8, the telephone-desk-set 90 includes a built-in bridge 94, or otherwise includes built-in circuitry that performs the functions of the bridge. The bridge 94 can be the same as, or similar to, the bridge 16 of FIGS. 2-4 such that the system has, or can have, identical or similar functionality as the desk phone 2, bridge 16, and mobile device 20 of FIGS. 2-4 as described in conjunction with FIGS. 1-7.

The integrated system also includes a docking station/receptacle 93 for the mobile-phone device 20, which is shown, in FIG. 8, docked with the station/receptacle. The station/receptacle 93 can include one or both of a power outlet or other power connector, one or more USB ports 95 for example, to charge the mobile-phone device, and a wireless charging pad to accommodate mobile devices that have the capability to be wirelessly charged. The station/receptacle 93 can include the bridge 94 or bridge circuitry, or the telephone desk set 90 can include the bridge or bridge circuitry. Furthermore, the station/receptacle 93 can be configured for permanent attachment to, or for detachment from, the telephone desk set 90. For example, the station/receptacle 93 can be configured for removable attachment to the desk set 90 via a “snap” mechanism or another quick-release mechanism. Or, the station/receptacle 93 can be separate from, and unattachable to, the desk set 90. Furthermore, the telephone desk set 90 can include a wired or wireless handset 91, which can include an integrated detachable wireless headset 92. For example, where the handset 91 is wireless, it can be configured to communicate with the telephone desk set 90 in any conventional manner, such as via Bluetooth® or via a Digital Spread Spectrum (DSS) protocol, and can include a battery (not shown in FIG. 8) that is rechargeable via a conventional power connection (not shown in FIG. 8) between the desk set and the handset. Similarly, the headset 92 can be configured to communicate with the telephone desk set 90 via the handset 91, or directly with the telephone desk set, in any conventional manner such as Bluetooth® or DSS, and can include a battery (not shown in FIG. 8) that is rechargeable via a power connection (not shown in FIG. 8) between the handset and the headset.

The integrated system of FIG. 8 can operate in the same manner, or in a manner similar to the manner, in which the desk phone 2, bridge 16, and mobile-phone device 20 of FIGS. 2-3 operate as described above in conjunction with FIGS. 4-7.

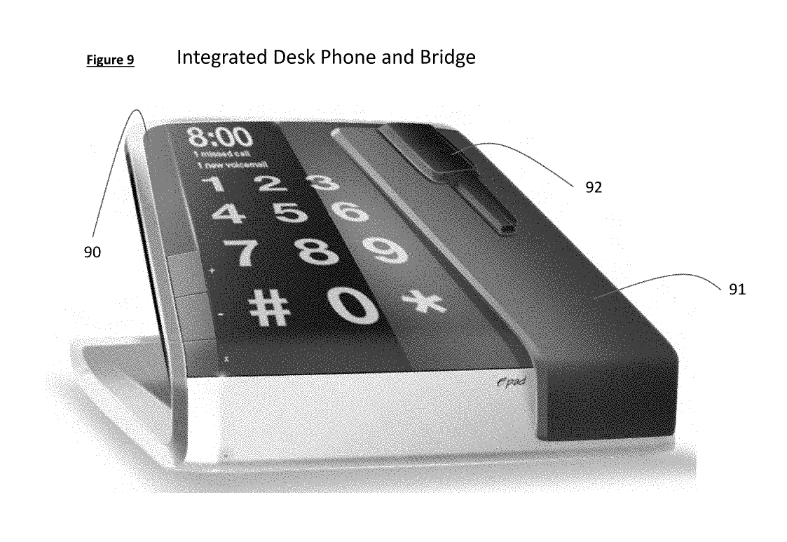

FIG. 9 is a diagram of the telephone desk set 90 of the integrated system of FIG. 8, according to another embodiment. The station/receptacle 93 (not shown in FIG. 9) can be omitted from the integrated system or can be included in the system but lack the bridge 94 or bridge circuitry, and the telephone desk set 90 can include the bridge or bridge circuitry (not shown in FIG. 9). Or the station/receptacle 93 can be part of the integrated system, can be located remote from the telephone desk set, and can include the bridge or bridge circuitry. In the former case, the telephone desk set 90 can be configured to communicate directly with the mobile device (not shown in FIG. 9); in the latter case, the telephone desk set can be configured to communicate with the mobile device via the station/receptacle 93, whether the mobile device is docked with the station/receptacle, or is undocked from the station/receptacle but otherwise in communication (e.g., over a wireless channel) with the station/receptacle.

The combination of the telephone desk set 90 of FIG. 9 and the station/receptacle 93 (with the docked mobile device) of FIG. 8 can operate in the same manner, or in a manner similar to the manner, in which the desk phone 2, bridge 16, and mobile-phone device 20 of FIGS. 2-3 operate as described above in conjunction with FIGS. 4-7.

FIG. 10 is a diagram of the station/receptacle 93 of the integrated system of FIG. 8, and of a repurposed desk phone 96, which can be configured to communicate with the station/receptacle in a wired or wireless manner, according to an embodiment. For example, because the repurposed desk phone is available, the station/receptacle 93 can be provided, and can be configured to operate, without the telephone desk set 90. In such an embodiment, the station/receptacle 93 includes the bridge 94 or bridge circuitry (FIG. 8), and the telephone desk set 90 can be omitted from the integrated system because, in effect, the repurposed desk phone takes the place of the telephone desk set.

The combination of the station/receptacle 93 (with the docked mobile device) and the desk phone 96 of FIG. 10 can operate in the same manner, or in a manner similar to the manner, in which the desk phone 2, bridge 16, and mobile-phone device 20 of FIGS. 2-3 operate as described above in conjunction with FIGS. 4-7.

Referring to FIGS. 8-10, one or more of the telephone desk set 90, handset 91, headset 92, docking station/receptacle 93, bridge circuitry 94, and desk phone 96 can include circuitry for performing any of the functions described herein, and the circuitry can be hardwired for such operation, can be configured for such operation by software or firmware, or can be configured according to a combination or subcombination of hardwiring, software, and firmware.

From the foregoing, it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated. Moreover, circuit components described above may be disposed on a single or multiple IC dies to form one or more ICs, these one or more ICs may be coupled to one or more other ICs. In addition, any described component or operation may be implemented/performed in hardware, software, firmware, or a combination of any two or more of hardware, software, and firmware. Furthermore, one or more components of a described apparatus or system may have been omitted from the description for clarity or another reason. Moreover, one or more components of a described apparatus or system that have been included in the description may be omitted from the apparatus or system.

What is claimed is:

1. An electronic bridge, comprising:
a first transceiver circuit configured
to receive a voice-device identifier and a first voice signal from a first telephone that is disconnected from a telecommunication network, and
to transmit a second voice signal to the first telephone;
a second transceiver circuit coupled to the first transceiver circuit and configured
to transmit the first voice signal to a second telephone that is coupled to a telecommunication network, and
to receive the second voice signal from the second telephone; and
a control circuit coupled to the first and second transceiver circuits and configured to cause the second telephone to dial a number of a voice device in response to the voice-device identifier, the voice device configured to receive the first voice signal from the second telephone over the telecommunication network and to transmit the second voice signal to the second telephone over the telecommunication network.

2. The electronic bridge of claim 1 wherein the voice-device identifier includes the number of the voice device.

3. The electronic bridge of claim 1 wherein:
the voice-device identifier includes an extension associated with the voice device, the extension being shorter than the number of the voice device; and
the control circuit is configured
to determine the number of the voice device in response to the extension, and
to cause the second transceiver to transmit the number to the second phone.

4. The electronic bridge of claim 1 wherein the control circuit is configured:
to generate a command to the second phone to dial the number of the voice device; and
to cause the second transceiver circuit to transmit the command to the second telephone.

5. The electronic bridge of claim 1 wherein:
the first phone includes a desk phone;
the second phone includes a mobile phone; and
the telecommunication network includes a cellular network.

6. The electronic bridge of claim 1 wherein the first transceiver circuit is configured to receive the voice-device identifier and to transmit the second voice signal over a cable coupled to the first transceiver circuit and the first telephone.

7. The electronic bridge of claim 1 wherein the first transceiver circuit is configured to receive the voice-device identifier and to transmit the second voice signal over a wireless channel between the first transceiver circuit and the first telephone.

8. The electronic bridge of claim 1 wherein the second transceiver circuit is configured to transmit the first voice signal and to receive the second voice signal over a wireless channel between the second transceiver circuit and the second telephone.

9. The electronic bridge of claim 1 wherein the telecommunication network includes the internet.

10. The electronic bridge of claim 1, further comprising:
a memory; and
wherein the control circuit is configured
to determine whether configuration data for the first phone is stored in the memory,
if configuration data for the first phone is stored in the memory, then to cause the first transceiver circuit to upload the configuration data from the memory to a memory of the first phone, and
if the configuration data for the first phone is not stored in the memory, then
to cause the second transceiver circuit to send, to the second phone, an instruction to retrieve configuration data for the first phone from a storage location coupled to the telecommunication network,
to cause the second transceiver circuit to download, to the memory, the configuration data retrieved by the second phone, and
to cause the first transceiver circuit to upload the retrieved configuration data from the memory to a memory of the first phone.

11. The electronic bridge of claim 1, further comprising:
a memory;
wherein the second transceiver circuit is configured to receive configuration data from the second phone; and
wherein the control circuit is configured
to cause the second transceiver circuit to store the configuration data in the memory, and
to configure the control circuit in response to the configuration data.

12. A method, comprising:
receiving, with a first telephone, a voice-device identifier from a second telephone that is disconnected from a telecommunication network;
calling, with the first telephone in response to the voice-device identifier, a voice device over a telecommunication network;
receiving, with the first telephone, a first voice signal from the second telephone;
providing, with the first telephone, the first voice signal to the voice device over the telecommunication network.

13. The method of claim 12, further comprising:
receiving, with the first telephone, a second voice signal from the voice device over the telecommunication network; and
providing, with the first telephone, the second voice signal to the second telephone.

14. The method of claim 12, further comprising:
receiving, with the first telephone, a request to perform a call-related function from the second telephone; and
performing the call-related function with the first telephone.

15. A method, comprising:
receiving, with a bridge circuit, a voice-device identifier from a first telephone that is disconnected from a telecommunication network;
causing, with the bridge circuit in response to the voice-device identifier, a second telephone to call the voice device over a telecommunication network;
coupling a first voice signal from the first telephone to the second telephone; and
coupling, with the second telephone, the first voice signal to the voice device over the telecommunication network.

16. The method of claim 15, further comprising:
receiving, with the second telephone, a second voice signal from the voice device over the telecommunication network; and
coupling the second voice signal from the second telephone to the first telephone.

17. The method of claim 15, further comprising:
receiving, with the bridge circuit from the first telephone, a request to perform a call-related function; and
causing, with the bridge circuit, the second phone to perform the call-related function.

18. A system, comprising:
a first telephone that is disconnected from a telecommunication network; and
a bridge circuit configured
to receive a voice-device identifier from the first telephone,
to cause a second telephone connected to a telecommunication network to connect to a voice device via the telecommunication network in response to the voice-device identifier,
to route a first voice signal from the first telephone to the voice device via the second telephone and the telecommunication network, and
to route to the first phone a second voice signal that the voice device sends to the bridge circuit via the telecommunication network and the second telephone.

19. The system of claim 18, further comprising a dock configured to receive the second phone.

20. A non-transitory computer-readable medium storing instructions that, when executed by a computing apparatus, causes the computing apparatus, or one or more circuits under control of the computing apparatus:
to receive a voice-device identifier from a first telephone;
to cause a second telephone connected to a telecommunication network to connect to a voice device via the telecommunication network in response to the voice-device identifier;
to route a first voice signal from the first telephone to the voice device via the second telephone and the telecommunication network; and
to route to the first phone a second voice signal that the voice device sends to the bridge circuit via the telecommunication network and the second telephone.
